(19) United States
(12) Patent Application Publication
(10) Pub. No.: US 2017/0198970 A1
(43) Pub. Date: Jul. 13, 2017

(54) METHOD AND APPARATUS FOR TREATING LOGGING CABLE

(71) Applicants: HENRY H. LEGGETT, Livingston, TX (US); KEVIN L. NUTT, Richmond, TX (US)

(72) Inventors: HENRY H. LEGGETT, Livingston, TX (US); KEVIN L. NUTT, Richmond, TX (US)

(21) Appl. No.: 14/991,448

(22) Filed: Jan. 8, 2016

(51) Int. Cl. F27B 9/28; B65H 59/18; B65H 59/16; B21D 1/06; B23P 6/00

(52) U.S. Cl. CPC F27B 9/28; B21D 1/06; B23P 6/00; B65H 59/16; B65H 59/18

(57) ABSTRACT

A method and apparatus for removing permanent stretch characteristics of electromechanical cable by application of predetermined tension to a selected length of electromechanical cable within a cable processing arena. Movement of the cable from a pay-off reel into the cable processing arena and to the take-up reel is controlled by spaced capstans that also secure the length of cable in static position within a cable processing arena during cable stretching. Successive selected lengths of the cable are stretched for dissipating its permanent stretch characteristics and rendering the cable suitable for accurate well logging.

### RELATED PATENT APPLICATION

This patent application is related to U.S. patent application Ser. No. 14/311,183, filed on Jun. 20, 2014 by Henry H. Leggett and entitled “Method And Apparatus For Treating Logging Cable”, which application and the invention to which it pertains is incorporated herein by reference for all purposes.

### BACKGROUND OF THE INVENTION

Field of the Invention

The present invention relates generally to the use of electromechanical cable, typically logging cable, in the treatment of wells for enhanced production of petroleum products, such as crude oil, natural gas, distillate and other petroleum constituents. More particularly, the present invention concerns the use of electromechanical cable to accomplish precision location of the various well tools within wells to provide for well servicing activities. Even more specifically, the present invention concerns one or more processes that are employed to prepare an electromechanical logging cable by a cable stretching operation so that the permanent stretch characteristic of the cable is substantially eliminated, thereby permitting a well tool connected with the logging cable to be precisely located at a specified depth or position within a well simply by calculating the elastic stretch of the cable.

Description of the Prior Art

It is well known in the well drilling and completion industry that wells being drilled must be logged periodically to determine the characteristics of the earth formation and to confirm the location of the drill bit in the earth formation at any point in time. Well logging is typically accomplished by connecting a logging tool to an electromechanical cable, typically referred to as a logging cable, and running the logging tool into the wellbore. In order to accurately locate the logging tool within the wellbore and with respect to the formation various factors must be calculated including the stretch of the logging cable.

Electromechanical cable is typically manufactured with an inner armor having a left hand lay, which is encompassed by an outer armor having a right hand lay. Newly manufactured electromechanical cable typically has elastic stretch characteristics which can be easily calculated, but also has permanent stretch characteristics which are quite difficult to calculate. Each time the electromechanical cable is run down-hole for logging or other well service activities the permanent stretch characteristics of the cable change to some extent and adversely affect precision use of the cable, especially for well logging operations where logging instruments are employed to precisely measure the depth and location of subsurface formation characteristics. The logging data is then used to precisely locate well tools such as packers, perforation guns and the like with respect to the formation measurements. Consequently, newly manufactured electromechanical cable is not generally deemed to be acceptable for accurate well logging operations since it is difficult to precisely confirm the location of a logging tool within a well. For well logging activities well drilling organizations typically rely on the use of “seasoned” electromechanical cable, i.e., cable that has been run into a deep well and recovered to a spool 10 to 15 or more times.

During each cable run within a deep well a percentage of the permanent stretch characteristics of the cable is depleted and this percentage changes with each cable run. After the cable has been repeatedly run into a deep well and recovered to a cable spool a predetermined number of times, most of the permanent stretch characteristics has been depleted and the cable will have become “seasoned” to the point that only the elastic stretch of the cable need be calculated in order to accurately position a logging tool within a wellbore. Some well drilling companies maintain a deep non-productive well solely for seasoning newly manufactured electromechanical cable. Typically newly manufactured electromechanical cable must be transported to a designated nonproductive well and run into the well and retrieved a number of times, for example 10 to 12 times, before being transported to a well drilling site for use. Obviously, running and retrieving an electromechanical cable multiple times without achieving income producing work is a time consuming and expensive proposition. Yet, some well drilling organizations maintain a deep well, such as having a depth of 25,000 feet or more, for the sole purpose of facilitating the seasoning of new electromechanical cable to make it ready for accurate well logging and other well service activities.

It is desirable therefore, to provide a method or process and apparatus having the capability of accomplishing accurate and effective seasoning of newly manufactured electromechanical cable in one or more cable processing runs, thus minimizing the time and costs of cable seasoning activities by multiple runs of the cable in designated non-productive wells. Though newly manufactured electromechanical cable can be seasoned by running it over multiple spaced sheaves by application of tension force and heat during cable movement, according to an embodiment of the present invention, it has been determined by tests that cable seasoning may also be accomplished with a section of the cable engaging multiple sheaves and maintained in static condition within a cable processing arena during cable stretching. Thus, according to the preferred embodiment of the present invention long sections of electromechanical cable, for example 1000′ to 1,500′ or more, may be positioned statically about multiple sheaves with desired tension force being applied to the static cable section by power energized cable stretching movement of one or more of the sheaves.

### SUMMARY OF THE INVENTION

It is a principal feature of the present invention to provide a novel method and apparatus for applying controlled stretching and working of a newly manufactured electromechanical cable to remove or dissipate a sufficient amount of the permanent stretch characteristics of the cable to render it suitable for accurate well logging activities.

It is another feature of the present invention to provide a novel method and apparatus for processing electromechanical cable by application of controlled tension for cable stretching and controlled application of heat to the cable to temporarily soften polymer insulation of the typically 7 conductors of the cable and permit relative movement of the metal strands of the inner and outer armor.

It is also a feature of the present invention to accomplish stretching of significantly long lengths of electromechanical cable, such as 1,000′ to 1,500′ or more, by positioning a selected length of cable about multiple sheaves of a cable processing arena and imparting power energized tension applying movement to one or more of the sheaves so that the selected length of cable is maintained substantially static during stretching activity to achieve substantially permanent stretched or seasoned cable having its permanent stretch characteristics substantially removed.

Briefly, the various objects and features of the present invention are realized through the provision of a powered or driven capstan and a braking capstan that are located in spaced relation. Each of the capstans has a pair of spaced sheaves, such as 36″ diameter sheaves, each having an external spiral cable groove receiving multiple wraps, for example 10 to 12 wraps of the electromechanical cable, which prevent slippage of the cable as forces are applied to stretch the cable and remove its characteristics of permanent stretch. The spiral grooves of the capstans the grooves of the cable receiving sheaves have a geometric configuration that is designed to precisely fit the cross-sectional dimension and configuration of the electromechanical cable that is being processed. This feature also prevents slippage of the cable during its processing. Between the driven and braking capstans are located a number of sheaves that are arranged in groups, with the groups being spaced at desired distances for cable stretching. The sheaves can also have a diameter of about 36″, more or less. The groups of sheaves can be spaced in the order of from 1,000′ to about 1,500′ more or less as desired, establishing a cable stretching arena. Most of the sheaves of the groups have fixed positions, with the cable being located about them. One or more of the sheaves of the groups is mounted to a moveable power actuator, such as a hydraulic, pneumatic or electrically driven actuator, so apply stretching force to the statically maintained length of cable. The electromechanical cable is withdrawn from a supply spool that can be mounted on a turntable that is rotated to loosen the outer armor of the cable prior to application of force to stretch the cable. The supply or let-off spool or reel is oriented in spaced relation with the first of the capstans and is recovered by a take-up spool that is also oriented in spaced relation with the last of the capstans. The take-up spool can also be mounted on a turntable that is rotated to re-tighten the outer armor of the cable after the cable has been stretched. Alternatively, where loosening and re-tightening of the outer armor of the cable is not desired, the rotatable turntables may be eliminated and the cable may be fed from the let-off spool directly onto the sheaves of the first of the capstan and may extend from the last of the capstans directly to a take-up reel.

When heating of the cable is desired to render the polymer sheathing flexible before stretching of the cable, one or more cable heating devices are positioned between the spaced sheaves of the first of the capstans or at any other suitable location relative to the cable to be stretched. The cable heating device is preferably electrically energized, though it may be fired by a flammable gas such a propane, natural gas or by any other flammable substance. The cable heater is arranged and controlled to accomplish heating of a predetermined length of the cable to a sufficient temperature above ambient temperature to soften its polymer sheathing so that the cable can be stretched by application of controlled tension force. This feature relaxes the frictional resistance of the polymer insulation with the metal conductor strands of the cable and permits movement of the metal conductors relative to the polymer insulation during the cable stretching process. The cable heater device may be powered electrically for application of radiant heat to the cable as the cable is moved into position for stretching.

After being heated by the cable heater or heaters the cable is stretched and is then permitted to cool to ambient temperature so that the polymer insulation returns to its hardened state. If desired, the heated cable may be moved through a cooler device, such as a water cooler or refrigerated cooler, so that cooling and hardening of the electromechanical cable will occur more rapidly.

According to the preferred embodiment of the present invention, stretching of selected quite long sections of electromechanical cable is accomplished with the cable being wound about multiple sheaves and with cable stretching tension being applied with the cable being maintained substantially static, rather than being moved through multiple sheaves during stretching activity. Apparatus for cable stretching, including multiple sheaves and power energized sheave moving equipment is provided within the cable stretching arena. A practical length of cable is moved from a cable supply reel into the cable stretch arena around multiple sheaves under low tension, such as under 25% to 35% of the maximum tension for which the cable is designed. Static pull stretching tension is applied to this practical length of cable for a predetermined period of time causing the length of the cable to increase, permanently. This stretching tension may exceed 40% of the published breaking strength of a respective cable size. Tension force is applied to the cable by power energized movement of one or more of the sheaves of the stretching arena, such as by means of hydraulic, electrical or other precisely controllable power apparatus. Preferably the tension force to achieve stretching and permanent elongation of the cable is developed by moving particular sheaves in opposite directions or by moving a particular sheave in relation to the fixed sheaves. The stretching force may be increased or decreased as cable technology changes. After stretching, the tension will be reduced until the amount of stretch can be safely measured and documented.

During tension and heat processing a selected length of the cable is maintained in static condition and is engaged within the cable grooves of multiple spaced sheaves. After a section of the cable has been stretched to remove its permanent stretch characteristics the cable is then moved lengthwise by a driven capstan and a braking capstan to position a succeeding length of cable for stretching. The cable stretching activity can be repeated two or more times to ensure removal of virtually all of the permanent stretch of the cable, with the cable being wound on a drum for storage or shipment when the cable stretching operation has been completed.

The section of stretched cable will then be installed onto a takeup reel and a new section of cable will be moved from the supply reel into the cable processing or stretching arena. This process will be repeated as many times as is required to safely remove the permanent stretch from the complete length of cable of the supply reel. Specially designed clamps will be employed to attach starter cables to the cable section that is to be stretched. These clamps are designed to permit significant tension force to be applied to the cable, without causing damage to the cable insulation the electrical conductors or other cable components. These cable clamps ensure that a maximum amount of cable will be present in the stretching arena at any given time, insuring that all of the cable on the shipping reel will be stretched.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In the Drawings:

FIG. 1 is a schematic illustration showing an electromechanical cable processing system embodying the principles of the present invention and being arranged to loosen the outer cable armor, apply controlled tension and controlled heat to the cable during its processing for stretching and then re-tighten the outer cable armor after the cable has been stretched;

FIG. 2 is an isometric illustration showing a braking capstan that comprises one of the capstans of the schematic illustration of FIG. 1;

FIG. 3 is an isometric illustration showing a powered or driven capstan that comprises another one of the capstans of the schematic illustration of FIG. 1;

FIG. 4 is an isometric illustration showing a pair of spaced sheaves of a capstan and also showing a multiplicity of cable grooves of the sheaves, with an electromechanical cable being located within the cable grooves of the spaced capstan sheaves;

FIG. 5 is a schematic end view of a single conductor electromechanical cable that is manufactured at the present time by a well-known high quality cable manufacturer;

FIG. 6 is a schematic end view of a three conductor electromechanical cable that is being manufactured, sold and used at the present time;

FIG. 7 is a schematic end view of a seven conductor high quality electromechanical cable that is also being manufactured, sold and used at the present time;

FIG. 8 is a schematic illustration showing an electromechanical cable stretching system embodying the principles of the present invention and showing apparatus defining a cable stretching arena having multiple relatively moveable sheaves and power equipment for maintaining a selection of the cable in substantially static condition within a cable processing arena and controllably moving one or more of the sheaves to achieve stretching of the electromechanical cable section; and

FIG. 9 is a simplified schematic illustration showing let-off and take-up drums or reels, capstans for cable driving and braking and a power energized sheave for controlled application of tension force to a length of electromechanical cable for normalizing the cable by stretching to remove as much of the permanent stretch characteristics as is practical.

### DETAILED DESCRIPTION OF PREFERRED EMBODIMENT

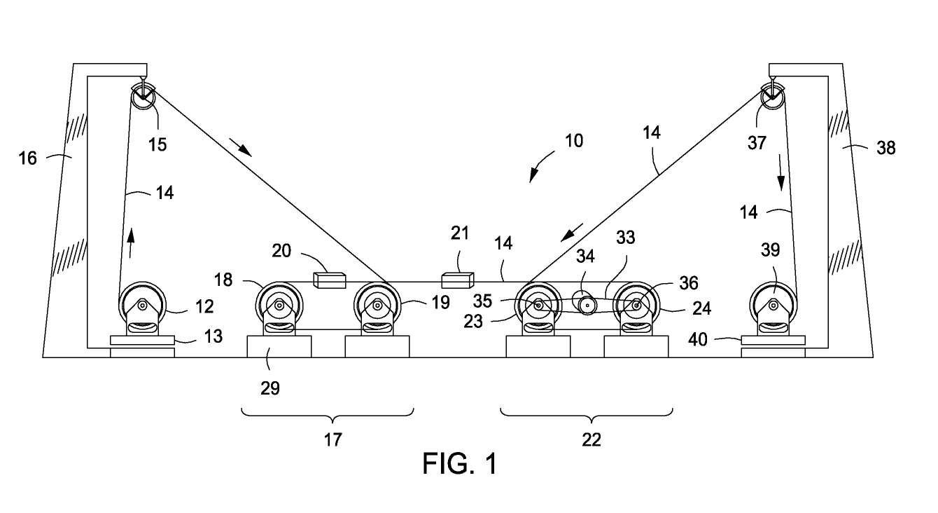

Referring now to the drawings and first to FIG. 1, a schematic illustration of an electromechanical cable processing system, generally at 10, includes a rotary supply reel or drum 12 that is mounted on a turntable 13 containing a length, for example 25,000 feet or more, of a particular type of newly manufactured electromechanical cable 14. The electromechanical cable typically has permanent stretch characteristics that prevent it from be used for logging services in wells. The electromechanical cable is withdrawn from the cable supply or let-off drum 12 and is directed upwardly and over a sheave 15 while the cable loosening turntable is rotated in a direction for loosening the outer spiral wound armor of the cable and consequently tightening the oppositely wound inner armor. As will be described in greater detail below when the finished cable is taken up it is rotated in the opposite direction by a similar turntable, thereby tightening the spiral wound outer armor substantially to its original condition of tightness and loosening the inner armor substantially to its original condition of tightness. This is done to permit the torque characteristics of the cable to remain balanced during its processing so that the torque characteristics of the finished cable will remain substantially the same as when the cable is removed from the cable supply drum 12. The cable extended upwardly from the cable supply drum 12 and is passed over a cable orienting sheave 15 that is supported by a sheave support structure 16. The cable is loosened during its linear travel from the cable supply drum to the cable orienting sheave 15. The electronically marked electromechanical cable 14 is then passed to a braking capstan shown generally at 17 having spaced externally grooved cable drums 18 and 19. The externally grooved cable drums 18 and 19 each have a plurality of external cable grooves that permit a number of cable wraps, for example 10 to 12 wraps, that extend about the spaced drums of the braking capstan. These multiple wraps of cable ensure against slippage of the cable when tension is applied either by braking activity or capstan driving activity or both. Between the spaced externally grooved sheaves 18 and 19 of the braking capstan 17 is located a cable heater 20 that is positioned to accomplish heating of the cable while it is under tension.

The cable may be passed through the cable heater or it may pass in close proximity with the heater so that it is heated to a controlled temperature due to the thermal output of the heater and the speed of substantially continuous cable movement. A tension detecting ohmmeter 21 is located between the braking capstan 17 and a power driven capstan shown generally at 22 for continuously detecting the tension that is being applied to the cable and transmitting an electronic tension signal to the power driven capstan 22 for controlling the tension of the substantially continuously moving electromechanical cable 14 that is being applied by the combined tension developing action of the braking capstan 17 and the power driven capstan 22.

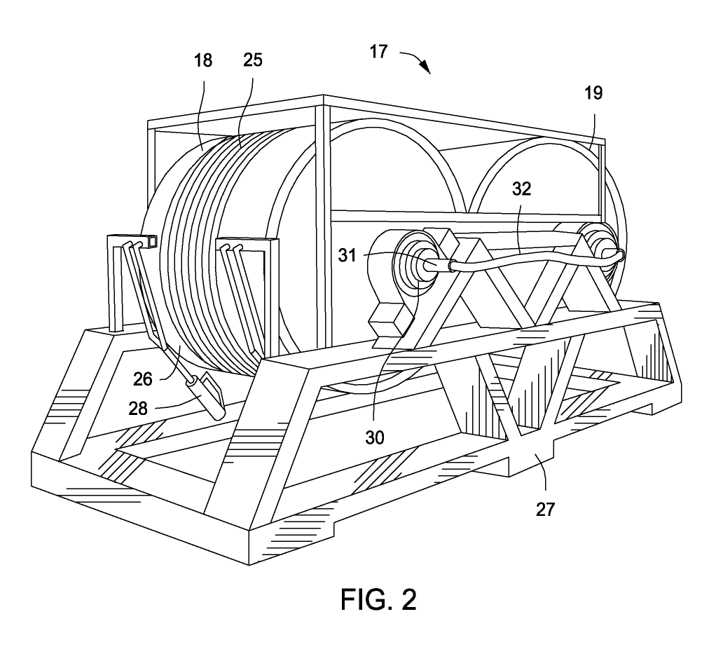

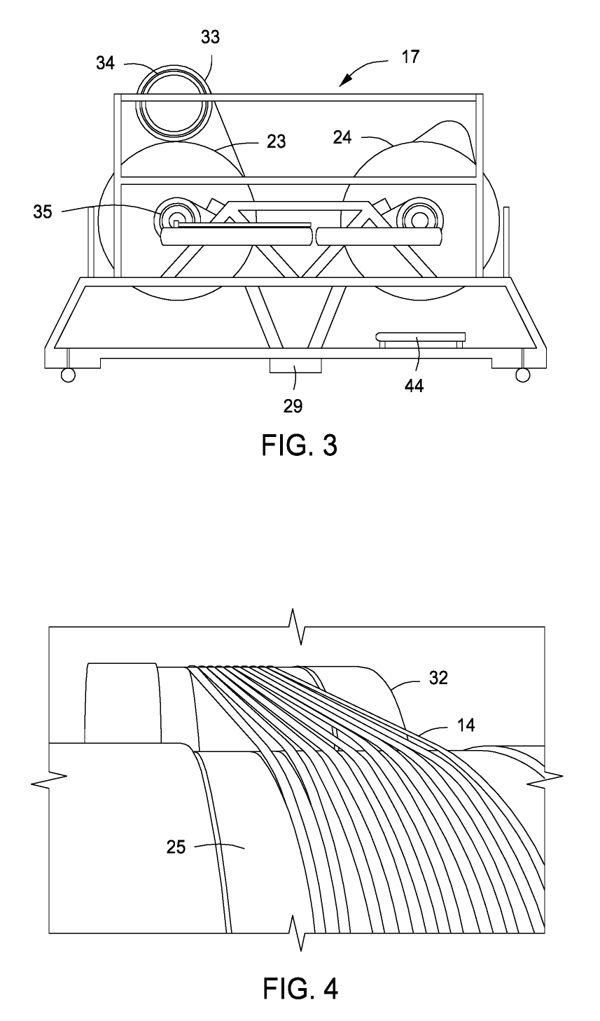

The power driven capstan 22 has a pair of spaced capstan drums 23 and 24, which, like the braking capstan 17, define multiple closely spaced cable grooves 25 that define multiple passes or wraps of cable within the grooves and about the spaced capstan drums as is evident in FIGS. 2 and 4. Typically, a safety cover, such as is shown in FIGS. 2 and 3, is positioned about each of the capstans to prevent workers from coming into contact with the cable grooves or the moving cable being treated. For purposes of simplicity, the capstan drums and multiple wraps of electromechanical cable are shown with the protective cover removed in FIGS. 1 and 4, so that the cable grooves and multiple wraps of cable can be visualized. At least one of the capstan drums 18 or 19 of the braking capstan 17 is provided with one or more brake members 26, as shown in FIG. 2 which is actuated by a hydraulic unit 28 to restrain rotation of the capstan drum and thereby create a braking action that subjects the electromechanical cable to tension as it traverses the multiple cable grooves of the spaced capstan drums and is subjected to tension by the force of the rotating drums of the powered capstan 22. The hydraulic unit 28 may be provided in the form of a hand-pump variety if desired, or it may be mechanically or electro-mechanically controlled to provide the braking system with accurate brake control for maintenance of predetermined cable tension. Capstan drum support structure 29 provides support for drum bearings 30 that provide for rotatable support for the capstan drums. The bearings are provided with a lubricant supply system and have a central passage 31 through which water or other coolant fluid is fed to and from the internal coolant compartment of the capstan drums.

Since substantially continuous application of capstan braking generates considerable heat, the drums 18 and 19 of the braking capstan 17 are of hollow construction, each defining a coolant compartment that contains a volume of coolant fluid such as water. A coolant supply and a coolant receptacle are in heat controlling communication with the coolant compartment and are controlled to ensure that heating of the braking capstan drum or drums is maintained within a predetermined range of temperature. Coolant to and from the internal coolant compartment is provided by passages that are located centrally of the drum bearings 23 and are connected with a coolant supply manifold 32.

A drive belt 33 is driven by a motor 34, such as a rotary electric motor, pneumatic motor or rotary hydraulic motor, and is received by drive pulleys 35 and 36 for driving the drums 23 and 24 of the powered capstan. The drums 23 and 24 of the powered capstan also have multiple cable grooves to establish multiple wraps of cable that extend about the drums and prevent slippage of the cable. The cable leaving the power driven drum 23 extends upwardly to a sheave 37 that is supported by a sheave support structure 38 and is then directed to move downwardly for collection by a take-up spool 39. The take-up spool is mounted for rotation by a turntable 40 which is rotated in a direction for tightening the outer armor of the electromechanical cable 14 and returning the cable to the same conditions as when it is removed from the let-off or cable supply drum 12. The driven capstan 30 is also provided with a braking system that is similar or identical, as compared with the braking system of the capstan shown in FIG. 2 and which is operated by a hydraulic actuator 44, such as a hand-pump or powered actuator.

Referring again to FIG. 1, spaced from the braking capstan 20 is a driven capstan shown generally at 30 having spaced externally grooved capstan drums 32 and 34 which may be substantially identical in size and geometry as compared with the braking capstan drums 22 and 24. The capstan drums are rotatably supported by bearings 36 that are in turn supported by a capstan drum support structure 38. At least one of the capstan drums 32 is rotatably driven by a drive belt 40 that is driven by a rotary motor 42, such as an electric motor, hydraulic or pneumatic motor. The driven capstan 30 is also provided with a braking system that is similar or identical, as compared with the braking system of the capstan shown in FIG. 2 and which is operated by a hydraulic actuator 44, such as a hand-pump or powered actuator.

As mentioned above, heating of the electromechanical cable 14 while it is maintained under predetermined tension is also an important aspect of the present invention. A predetermined length of the cable is heated to soften the polymer insulation of the conductors so that relative movement of the conductors can occur in response to the tension being applied to the cable by the braking and driven capstans, thereby causing most if not virtually all of the permanent stretch characteristics of the cable to be dissipated, leaving the cable in seasoned condition and ready for use during well logging activities. The cable heater 20 is supported between the rotary cable drums of the braking capstan as shown in FIG. 1 and applies radiant heat for a sufficient period of time, while the cable is continuously moving to achieve predetermined softening of the polymer insulation of the conductors and resulting in conductor movement relative to the softened polymer insulation in response to the continuous application of predetermined tension to the cable. As the treated electromechanical cable 14 leaves the proximity of the heater 20 it is typically cooled by ambient temperature. If desired, the heated and treated cable may be controllably cooled by means of refrigerated air or by passing it through a water bath.

The treated electromechanical cable 14 is then passed about a return sheave 37 that is rotatably supported by a sheave support structure 38. The take-up reel or drum 39 is rotatably supported by a turntable 40 and serves to receive the treated and seasoned electromechanical cable 14. Starting and end portions of the cable will not have been adequately treated by application of tension and heat and thus will need to be discarded or electronically marked so that the treated and seasoned section of the cable can be easily identified as the cable is used for well logging and many other activities where the tensile strength and permanent stretch characteristics must be taken into consideration.

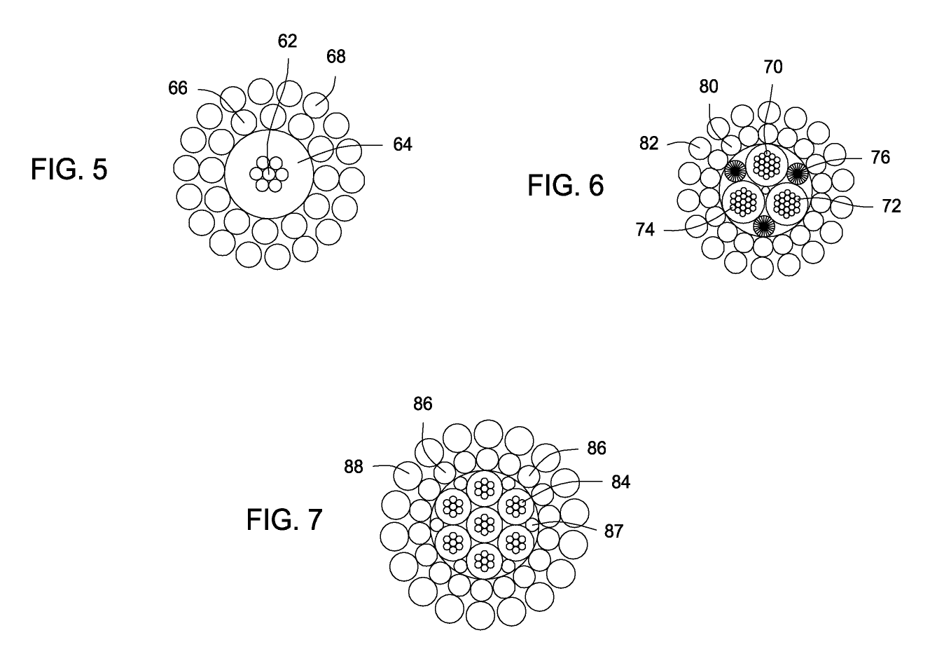

Electromechanical cable for well logging and for other purposes are manufactured in many different forms. FIGS. 5-7 illustrate three forms of electromechanical cable that are currently manufactured and are widely used throughout the well drilling and completion industry. In FIG. 5 the cable has a single conductor 62 that comprises seven strands of metallic conductor wire. Polymer insulation 64 covers the single conductor and is surrounded by inner armor 66 that comprises a number twisted metal wires that are wound about the conductor and an outer armor 68 that also comprises a number of twisted metal wires. As mentioned above, the outer armor typically has a left hand lay while the inner armor has the opposite, or right hand lay. While the electromechanical cable is run into a well the outer armor becomes loosened and the inner armor becomes tightened.

In FIG. 6 a three conductor electromechanical cable is shown, having three polymer coated conductors 70, 72 and 74 with structural members 76 located in conductor grooves. A water barrier 78 surrounds the polymer coated conductors and the structural members to prevent damage by salt water and other well constituents. The cable is provided with a spiral wrapped inner armor 80 and an oppositely spiral wrapped outer armor 82 that are composed of oppositely twisted wires. As mentioned above, the inner armor is composed of multiple wires having a left hand spiral lay and the outer armor is composed of multiple wires having a right hand spiral lay. It should be borne in mind that loosening the outer armor causes tightening of the inner armor.

In FIG. 7 a seven conductor electromechanical cable is shown having seven polymer coated electrical conductors 84 which are contained within a water barrier 86. Structural strands 87 are would within external grooves that are defined by the coated conductors 84. An inner armor 86 and an outer armor 88 are oppositely would about the water barrier 86. Many other types of electromechanical cables are manufactured sold and used by the petroleum industry for well logging and other well servicing activities and can be treated by application of tension and heat for permanent stretch dissipation and seasoning.

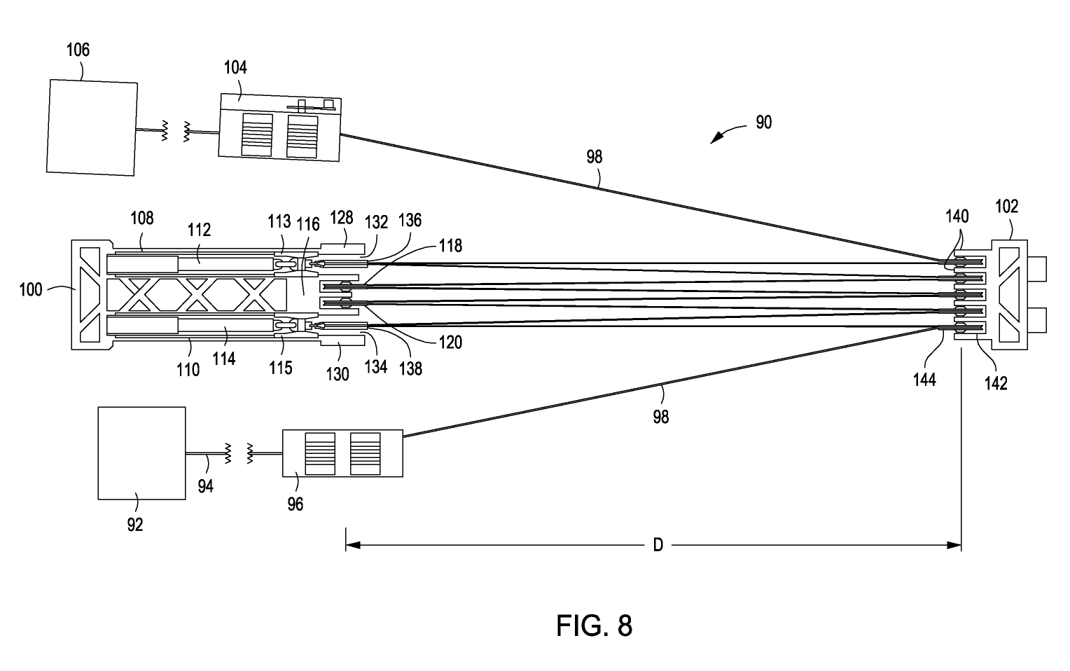

As mentioned above, it has been determined by tests that cable seasoning may also be accomplished with the cable being controllably stretched while being maintained in substantially static condition. The following embodiment of the present invention, illustrated diagrammatically in FIG. 8 shows long sections of electromechanical cable, for example 1000′ to 1,500′ more or less, being positioned statically about multiple sheaves with desired tension force being applied to the cable by power energized movement of one or more of the sheaves. FIG. 8 shows a cable tension processing system for electromechanical cable, generally at 90 having a payoff or supply reel 92 supporting a quantity of newly manufactured electromechanical cable 94 to be mechanically stretched and seasoned by application of controlled tension force. A capstan 96 having braking capability receives the newly manufactured cable 94 from the supply reel 92 in readiness for cable stretching and can employ a cable clamp to secure a selected length 98 of the cable, 1,000′ to 1,500′ more or less, against significant movement during the stretching process. It should be noted that the selected length of cable is the cable that extends from the braking capstan 96 over multiple sheaves and is received by a power capstan 104 that also has braking capability. From the power capstan 104 the selected length 98 of the cable, after having been stretched and seasoned is taken up by a take-up reel 106 that will serve during transportation and storage of the seasoned cable in readiness for use.

A cable stretching arena is generally defined by the space or area between a primary sheave support 100 and a secondary sheave support 102. The sheave and power support frame 100 defines a pair of generally parallel slide tracks 108 and 110 that provide support and guidance for sheave mount members that are moved by power actuators 112 and 114. Within the spirit and scope of the present invention, the power actuators may take the form of a pair of hydraulic cylinder motors as shown in FIG. 8 or may have the form of pneumatic cylinder motors, mechanical or electrical motors or any other powered apparatus that accomplishes substantially linear sheave movement for application of tension to the selected length of cable. The power actuators 112 and 114 accomplish linear movement of moveable sheave mount members 113 and 115 to which sheaves are mounted. The sheave mount members are secured to the power actuators by force transmitting connectors and slide along the slide tracks 108 and 110 when tension force or tension relaxing movement occurs. A central sheave mount structure 116 of the power support frame 100 provides independent support for interior sheaves 118 and 120 each having independent sheave support shafts.

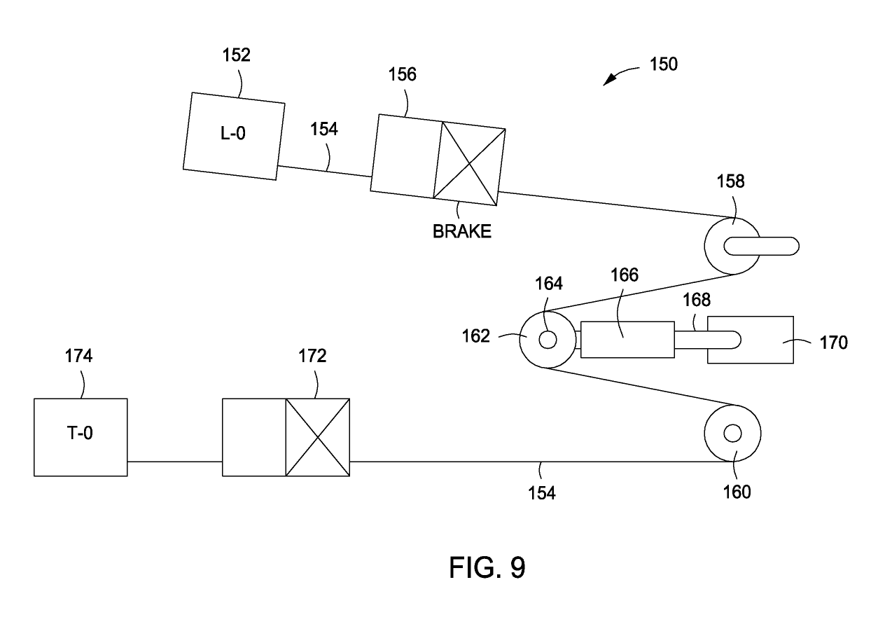

Each of the sheaves has a diameter in the range of about 36″, though the diameter can be larger or smaller depending on the desires of the user. The sheaves are provided with a cable groove 125, as shown in FIG.9 that is designed to receive an electromechanical cable of a particular size range. Typically the sheave wheels 122 are composed of a durable metal, such as steel, and define an outer peripheral sheave groove 124 to which is molded or bonded a protective coating or groove lining 126 that is composed of a suitable polymer material or composite such as Nylon®, Nyletron®, Teflon® or any one of a number of suitable durable polymer materials that provide protection for the polymer shielding components of the cable during the cable stretching process. The groove lining material 126 defines a cable groove 125 that is particularly designed to receive electromechanical cable of a particular design and cross-sectional dimension.

The power support frame 100 defines external sheave support structure 128 and 130 having sheave support receptacles 132 and 134 within which are moveably received exterior sheaves 136 and 138. These sheaves are each supported by independent sheave axle shafts to provide for independent sheave movement during the cable stretching operation. The large size of the sheaves and the independent sheave rotation movement permits the electromechanical cable engaging the sheave grooves to be stretched to substantially the same extent as the cable extending distance D between the sheaves so that all of the selected length of cable 98 will be evenly stretched and the permanent stretch will have been removed.

The sheave support block 102 is located a sufficient distance from the power support frame 100 so that a selected distance D, for example 1,000′, is established between the spaced sheaves so that each run of electromechanical cable to be stretched will be about 1,000′ in length. If the cable is passed around 9 sheaves within the stretching arena, including substantially equal cable lengths from the payoff reel to the first sheave and from the last sheave to the take-up reel, then the length of cable being statically stretched during each cable stretching cycle will amount to about 10,000′. The sheave support block 102 is fixed during the cable stretching operation, but may be set at any desired distance D from the sheaves of the power support frame 100 to accomplish stretching of a desired length of the cable. The sheave support block 102 has a plurality of sheave support flanges 140 having sheave grooves 142 within which a plurality of sheaves 144 are located. Each of the sheaves is supported for free rotation by an independent sheave axle so that each sheave will be rotated by the cable engaging it to cause even distribution of the tension force that is being applied to the selected cable length at any point in time.

With reference to FIG. 9, a schematic illustration of a cable processing arena is shown generally at 150 which embodies the principles of the present invention. A supply of electromechanical cable is provided on a supply or let-off reel 152 and the cable 154 is moved from the let-off reel by tension force that is applied by a first capstan 156 that is both a cable driving and cable braking capstan. The cable is received by the cable grooves of substantially fixed sheaves 158 and 160 that are each rotatable about independent sheave axle shafts of a sheave support. A moveable sheave member 162 receives the electromechanical cable and has an independent axle shaft 164 that is moved and positioned by a power actuator 166, such as a hydraulic or pneumatic actuator that is mounted by a connector 168 to an actuator support member 170 that is positioned substantially immovably within the cable processing arena. As shown and described above in connection with FIG. 8, from the last sheave member 160 the electromechanical cable 150 is retrieved or stabilized by the tension force of a second capstan 172, which is a braking capstan, but may also have a rotary driving capability as well.

Typically the braking systems of the first and second capstans are energized to prevent linear movement of the electromechanical cable during its processing by stretching activity. The selected length of cable that is located within the cable processing arena is maintained substantially static by the braking activity of the first and second capstans and tension force is applied to the cable by power energized movement of the sheave 162 by means of the power actuator 166. After having been stretched to remove the permanent stretch characteristics of the cable, the cable is moved to a take-up reel 174. If desired, depending on the type and size of the electromechanical cable being processed, the cable may be subjected to the normalization process two or more times to ensure removal of virtually all of the permanent stretch characteristics.

The Cable Seasoning Process

According to the embodiment of FIG. 1 a length of electromechanical cable is provided on a supply or payoff reel or drum 12 that is mounted for rotation by a turntable 13. As the cable is pulled from the supply drum 12 upwardly about the cable direction sheave the turntable 13 is rotated in a direction for loosening the outer armor. The outer cable armor which is composed of multiple wires that are wrapped in spiral fashion about the insulation or other wires of the cable with the spiral having a right hand lay. After the cable has been retrieved from the supply reel and loosened by rotation of the turntable 13, multiple wraps of the cable are positioned within the external cable grooves of the spaced drums of a braking capstan.

As the last wrap of electromechanical cable is pulled from the first cable drum of the braking capstan a cable heater located between the drums of the braking capstan heats a section of the cable to sufficient temperature for softening of the polymer insulation of the conductors of the cable. The braking action of the braking capstan and the pulling force of the power driven capstan cause this predetermined section of the cable to be subjected to tension, thus subjecting the loosened cable to stretching activity to remove substantially all of the permanent stretch characteristics of the cable.

Loosening of the electromechanical cable together with the application of controlled heating in the loosened condition of the cable enhances the cable stretching capability. Subsequent cooling of the heated section of cable will permit the polymer insulation to harden to its original condition, thus stabilizing the stretched cable so that the resulting treated cable will remain with its characteristic of permanent stretch removed. The multiple external cable grooves of each pair of spaced cable drums of the braking and power driven capstans effectively prevents slippage of the cable during the precisely controlled cable stretching process. The cable is loosened to start the tension and heat responsive seasoning process.

The electromechanical cable is supplied on a let-off drum that is mounted for rotation by being supported by a rotary turntable. As the electromechanical cable is paid out from the let-off or cable supply drum the turntable is rotated in a direction for loosening the spiral wound outer armor of the cable and for tightening the oppositely wound inner armor. The leading end of the electromechanical cable is contacted by a tension control sheave and is looped about a return sheave and is connected to a take-up reel or drum. The electromechanical cable is also passed through or in close proximity with a heater unit that is located between the drums of the braking capstan and may also be passed through or in close proximity with a cable cooling unit the is located downstream from the heater unit. The cable remains torque balanced during the stretching or seasoning process so that the torque characteristics of the finished cable are substantially the same as when the cable seasoning process is started.

With the brake of the braking capstan set for application of predetermined tension to the electromechanical cable and with the heater unit in operation, the driven capstan is actuated to move the cable substantially continuously and to apply predetermined tension to the cable as it is moved through or in close proximity with the heater unit to soften the polymer insulation of the conductors and permit relative movement of the conductors with respect to the polymer insulation surrounding the conductors. The application of heat and tension to the cable causes the permanent stretch characteristics of the cable to be virtually dissipated, leaving the cable seasoned for accurate and efficient use during well logging activities.

Though a pair of double drummed capstans are preferably employed for applying controlled tension to the electromechanical cable during processing for dissipation of the permanent stretch characteristics of the cable, it is to be understood that the present invention is not restricted or limited to this particular arrangement of cable stretching apparatus. The present invention is practiced by employing any suitable apparatus for application of controlled tension to the electromechanical cable and by applying predetermined heat to the cable while it is under tension to thus permit cable stretching for the purpose of removing or dissipating the permanent stretch characteristics of the cable. controlled movement of the cable conductors relative to the polymer coating that is present and then causing hardening of the polymer coating while the cable is maintained under tension. As the cable is being processed the torque characteristics of the cable remains balanced. As the cable seasoning process is completed the cable is passed about tension control and return sheaves and is then recovered to a take-up spool or drum, thus readying the cable for shipment to a site for use in well logging or other well servicing activities.

According to the embodiment of the present invention shown in FIG. 8, the sheave support block 102 is positioned at a desired distance D, for example 1,000′ to 1,500′ from the axes of the array of multiple cable stretching sheaves that are supported by the sheave support frame 100. The position of the sheave support block 102 is preferably fixed during the cable stretching process, though its position may be adjusted to establish desired distance of the cable stretching sheaves 142 from the moveable sheaves of the support frame 100. To initiate the cable stretching process a desired length of the electromechanical cable 94 is fed or pulled from the payoff reel 92, such as being pulled by the powered capstan 96, which has a braking system for cable payout tension control. The length of electromechanical cable 94 is passed through the cable groove of each sheave of the array of multiple cable stretching sheaves 142 and the moveable sheaves of the support frame 100, with the forward end of the selected length of cable being passed through the powered capstan 104 and positioned to be received by the takeup reel 106. The powered capstans are controlled during the cable threading process so that a small tension force, such as from 20% to 40% of the designed cable stretching force is continuously supplied to maintain proper orientation of the cable relative to the various sheaves.

With the electromechanical cable in place within the cable grooves of the various sheaves, essentially as shown in FIG. 8, the power actuators 112 and 114 of the cable stretching apparatus will be activated, moving the sheaves 136 and 138 toward the support frame 100 or to the left as shown in FIG. 8, applying substantially equal tension force to each of the cable runs of the selected length 98 of cable. The cable stretching apparatus is provided with sensor apparatus and accurate controls to ensure that the tension force being applied to the cable 98 is accurately measured and recorded. Apparatus is also provided to mark measured lengths of the cable, such as by laser printing after the cable stretching operation has been completed. These features permit the ultimate customer to be provided with precision documentation of the processed cable that has been received and permits customers to select the parameters of the cable stretching process when cable stretching is ordered.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

We claim:

1. A method for processing electromechanical cable to substantially dissipate the permanent stretch characteristics thereof in preparation for use of the electromechanical cable for well logging and the like, comprising:
positioning a selected length of electromechanical cable within a cable processing arena;
maintaining said selected length of electromechanical cable in substantially static relation within said cable processing arena; and
applying sufficient tension force to said selected length of electromechanical cable to stretch said selected length of electromechanical cable and remove most of the permanent stretch characteristics thereof.

2. The method of claim 1, comprising:
supporting said selected length of electromechanical cable on a plurality of cable receiving sheaves during said application of tension force thereto.

3. The method of claim 2, comprising:
moving one of said cable receiving sheaves to apply said tension force to said selected length of electromechanical cable.

4. A method for processing electromechanical cable to substantially dissipate the permanent stretch characteristics thereof in preparation for use of the electromechanical cable for well logging and the like, comprising:
positioning a selected length of electromechanical cable within a cable processing arena having a pair of spaced sheave groups each sheave group having plurality of rotatable cable receiving sheaves and one of said cable receiving sheaves being mounted for power energized linear movement;
maintaining said selected length of electromechanical cable in substantially static relation within said cable processing arena and moving said one of said cable receiving sheaves linearly and applying sufficient tension to said selected length of electromechanical cable to stretch the electromechanical cable and substantially dissipate the permanent stretch characteristics thereof;
causing linear movement of said selected length of electromechanical cable relative to said plurality of spaced sheave groups and from said cable processing arena and moving a succeeding selected length of said electromechanical cable onto said plurality of cable receiving sheaves of said spaced sheave groups; and
repeating said method steps until substantially all of said electromechanical cable has been processed.

5. The method of claim 4, comprising:
feeding said selected length of electromechanical cable linearly from a let-off spool into said cable processing arena and onto said plurality of sheaves for processing;
and retrieving the processed electromechanical cable from said cable processing arena to a take-up spool after said selected length of electromechanical cable has been processed.

6. The method of claim 5, comprising:
feeding said selected length of electromechanical cable from said let-off spool into said cable processing arena with a first capstan;
retrieving said selected length of electromechanical cable to said take-up spool with a second capstan; and
maintaining said substantially static position of said selected length of electromechanical cable during cable stretching processing with said first and second capstans.

7. The method of claim 6, comprising:
during said feeding step causing selective power energized linear movement of said selected length of electromechanical cable from said let-off spool into said cable processing arena by power energized rotary movement of rotary drive members of said first capstan; and
during said cable processing step, retaining said selected length of electromechanical cable in static position by braking activity of said first capstan and by braking activity of said second capstan.

8. The method of claim 4, comprising:
applying heat to said selected length of electromechanical cable to raise the temperature of the cable above ambient temperature to soften the polymer insulation thereof to permit relative movement of metal conductors and polymer insulation thereof and enhancing stretching and permanent stretch dissipation by application of tension force thereto during processing.

9. A method for stretching electromechanical cable to substantially dissipate the permanent stretch characteristics thereof, comprising:
feeding a selected length of electromechanical cable from a payoff reel;
threading said selected length of electromechanical cable through multiple sheaves of a primary sheave support having a moveable sheave and a secondary sheave support located a desired distance from said primary sheave support and having a powered actuator controllably moving said moveable sheave;
securing said selected length of electromechanical cable in substantially static relation;
with said powered actuator moving said moveable sheave and imparting cable stretching tension to said selected length of electromechanical cable and stretching said selected length of electromechanical cable sufficiently to substantially dissipate the permanent stretch characteristics thereof; and
taking up said selected length of electromechanical cable on a take-up reel.

10. The method of claim 9, comprising:
said securing said selected length of electromechanical cable being accomplished by a powered capstan and a capstan having brakes, said powered capstan feeding said electromechanical cable from said payoff reel serially through said multiple sheaves of said primary and secondary sheave supports; and
maintaining braking with said powered capstan and braking capstan and preventing linear movement of said electromechanical cable during application of cable stretching tension.

11. The method of claim 10, comprising:
supporting each of said plurality of sheaves of said primary and secondary sheave supports for independent rotational movement about axles for each of said sheaves.

12. The method of claim 9, comprising:
loosening the outer armor of the electromechanical cable as it is moved from said supply drum;
moving the electromechanical cable linearly from a supply reel to a take-up reel;
applying predetermined tension to a section of the electromechanical cable causing movement of the electrical conductors relative to the polymer coating of the electromechanical cable and substantially dissipating the permanent stretch characteristics of the electromechanical cable;
tightening the outer armor of the electromechanical cable; and
recovering the stretched and tightened electromechanical cable to a take-up drum.

13. The method of claim 12, comprising:
said step of loosening the outer armor of the electromechanical cable being rotation of said cable supply drum in a direction opposite the spiral wrapping direction of the outer armor; and
said step of tightening the outer armor of the electromechanical cable being rotating the cable take-up drum in the direction of the spiral wrapping direction of the outer armor.

14. The method of claim 9, comprising:
applying predetermined heat to said section of electromechanical cable within said cable processing arena, said predetermined heat softening said polymer coating of said electrical conductors and permitting said movement of the metal electrical conductors relative to said polymer coating thereof and facilitating stretching thereof and substantially dissipating the permanent stretch characteristics thereof.

15. The method of claim 9, comprising:
establishing multiple wraps of the electromechanical cable within the spiral cable grooves of first and second spaced rotary cable drums;
causing braking activity of said first rotary cable drum; and
causing power energized rotary driving of said second rotary cable drum, said braking and driving applying said predetermined tension to the electromechanical cable with said cable being maintained substantially static within said cable processing arena.

16. Apparatus for applying tension to a predetermined length of electromechanical cable within a cable processing arena and substantially removing the permanent stretch characteristics thereof rendering it suitable for well logging activities, comprising:
a payoff reel mounted for rotation and having spooled thereon a length of electromechanical cable to be processed by stretching to substantially dissipate the permanent stretch characteristics thereof;
a take-up reel mounted for rotation and retrieving said length of electromechanical cable subsequent to processing thereof;
a cable processing arena having a section of said electromechanical cable located therein and having a pair of capstans maintaining said section of said electromechanical cable substantially static within said cable processing arena;
a pair of spaced sheave groups disposed in spaced relation within said cable processing arena and each spaced sheave group having a plurality of cable receiving sheaves being supported by sheave axles at substantially fixed locations; and
a power energized moveable sheave member engaging said electromechanical cable within said cable processing arena and being independently moveable for application of tension force causing stretching of said electromechanical cable within said cable processing arena.

17. The apparatus of claim 16, comprising:
a first capstan receiving electromechanical cable from said pay-off reel feeding a selected length of said electromechanical cable into said cable processing arena and resisting movement of said electromechanical cable by tension force during cable processing within said cable processing arena; and
a second capstan receiving said electromechanical cable and having braking activity resisting movement of said electromechanical cable by tension force during cable processing within said cable processing arena.

18. The apparatus of claim 16, comprising:
said first capstan having a pair of drive sheaves having spiral grooves receiving multiple wraps of said electromechanical cable preventing slippage of said electromechanical cable relative to said drive sheaves during cable feeding and during braking activity; and
said second capstan having a pair of drive sheaves having spiral grooves receiving multiple wraps of said electromechanical cable preventing slippage of said electromechanical cable relative to said drive sheaves during braking activity.

19. The apparatus of claim 16, comprising:
capstans moving a selected length of said electromechanical cable into said cable processing arena and maintaining said selected length of said electromechanical cable substantially static within said cable processing arena during cable stretching processing thereof;
an actuator mount being located within said cable processing arena;
a power actuator being supported by said actuator mount; and
a moveable sheave being moveable by said power actuator and applying tension force to said electromechanical cable causing stretching of said electromechanical cable and dissipating permanent stretch characteristics thereof.

20. The apparatus of claim 16, comprising:
a heater being located between said rotary braking drum and said power driven drum and being located in close proximity to said single length of the electromechanical cable, said heater being controlled to apply sufficient heat to a section of said single length of electromechanical cable during linear cable movement and while said single length of electromechanical cable is maintained under predetermined tension by said rotary braking drum and said rotary power driven drum to soften the polymer insulation of the cable conductors and permit relative movement of the electrical conductors and the polymer insulation;
said cable drums of said braking capstan defining coolant compartments; and
a coolant supply and receiving system being in fluid communication with said coolant compartments and circulating coolant fluid through said coolant compartments for removing brake generated heat from said cable drums.

21. The apparatus of claim 16, comprising:
said external spiral cable grooves of said rotary braking drum and said rotary power driven drum receiving multiple wraps of the electromechanical cable to ensure against slippage of the electromechanical cable within said external spiral cable grooves;
a brake system mounted for application of braking to said first rotary cable drum;
said rotary power driven drum applying tension to the electromechanical cable extending between said rotary braking and rotary power driven drums and causing substantially continuous linear movement of the electromechanical cable; and
a heater being located between said rotary braking drum and said power driven drum and being located in close proximity to the electromechanical cable, said heater being controlled to apply sufficient heat to the electromechanical cable during linear cable movement and while said single length of electromechanical cable is maintained under predetermined tension to soften the polymer insulation of the cable conductors and permit relative movement of the electrical conductors and the polymer insulation.
